(19) United States
(12) Patent Application Publication
(10) Pub. No.: US 2026/0185620 A1
(43) Pub. Date: Jul. 2, 2026

(54) DUAL VENTURI

(71) Applicant: KYUNGDONG NAVIEN CO., LTD., Pyeongtaek-si (KR)

(72) Inventors: Min Jin Lee, Seoul (KR); Seok Hwan Bae, Seoul (KR); Kyeong Wan Han, Seoul (KR)

(21) Appl. No.: 19/431,812

(22) Filed: Dec. 23, 2025

(30) Foreign Application Priority Data
Dec. 30, 2024 (KR) 10-2024-0201330

(51) Int. Cl. F16K 11/18; F24D 19/00

(52) U.S. Cl. CPC F16K 11/18; F24D 19/00

(57) ABSTRACT

A dual venturi includes a housing having a first gas flow path formed at one side thereof, a second gas flow path formed at the other side thereof and configured to communicate with the first gas flow path, and an air flow path formed in a central region thereof and configured to communicate with the first gas flow path, an air adjustment part provided with a rotary plate provided in the air flow path and configured to rotate about a rotary shaft disposed in a height direction of the housing to adjust an opening degree of the air flow path, and a gas adjustment part provided with an opening/closing plate configured to move in a width direction of the housing in conjunction with a rotational motion of the rotary shaft and installed to selectively allow the first and second gas flow paths to communicate with each other.

### CROSS-REFERENCE TO RELATED APPLICATION

This application claims priority to and the benefit of Korean Patent Application No. 10-2024-0201330 filed in the Korean Intellectual Property Office on December 30, 2024, the entire contents of which are incorporated herein by reference.

### TECHNICAL FIELD

The present disclosure relates to a dual venturi, and more particularly, to a dual venturi that optimizes control performance by converting a rotational motion for controlling an air adjustment part into a leftward/rightward rectilinear motion for controlling a gas adjustment part by using a single cam, and improves assemblability of the dual venturi by modularizing the gas adjustment part into an assembly.

### BACKGROUND ART

In general, combustors, such as boilers and water heaters, used for heating and hot-water applications, are classified into oil boilers, gas boilers, electric boilers, and water heaters in accordance with the types of supplied fuel. Various types of combustors have been developed and used in accordance with the installation purpose.

In particular, among the combustors, the gas boilers and the water heaters generally use Bunsen burners or premixed Burners in order to combust gaseous fuel. Among the burners, the premixed burner adopts a combustion method that mixes gas and air at a mixture ratio optimized for combustion and then supplies the gas mixture (air + gas) to a flame port to combust the gas mixture.

A venturi device for a boiler in the related art includes a mixing part, a gas supply part, and an air supply amount control device. The mixing part has a hollow shape. The mixing part has an air inlet port provided in a lower portion thereof, a gas inlet port provided in an outer surface thereof, and a discharge port provided at an upper side of the outer surface opposite to the gas inlet port. The mixing part is provided with a blower fan provided at an inner upper side thereof, and the blower fan is configured to rotate to induce air and gas to be introduced through the air inlet port and the gas inlet port. The gas supply part is connected to the gas inlet port and supplies gas to the gas inlet port. The air supply amount control device is installed to be spaced apart from the air inlet port of the mixing part at a predetermined distance and configured to adjust the amount of air to be introduced into the air inlet port by adjusting an opening gap of the air inlet port while moving upward or downward.

In this case, an opening area of a lower end of the mixing part is adjusted as a drive motor of the air supply amount control device moves a gap change part upward or downward. In this case, the amount of air, which is proportional to the opening area of the lower end of the mixing part, is supplied to the mixing part and mixed with gas introduced into the mixing part through the gas inlet port.

In this case, the amount of gas, which is introduced through the gas inlet port and supplied, is adjusted and controlled by the gas supply part.

However, the above-mentioned venturi device for a boiler in the related art is structured to separately adjust the amount of air, which is introduced between the lower end of the mixing part and the gap change part, and the amount of gas introduced through the gas inlet port, which requires a large number of components configured to adjust the gas supply amount. As a result, there is a problem in that a large amount of time is required to design and assemble the venturi device, and there is an inconvenience of having to separately adjust the amount of gas to be introduced through the gas inlet port so that the amount of gas is proportional to the amount of air to be supplied into the mixing part.

### SUMMARY

The present disclosure has been made in an effort to solve the above-mentioned problem, and an object of the present disclosure is to provide a dual venturi that optimizes control performance by converting a rotational motion for controlling an air adjustment part into a leftward/rightward rectilinear motion for controlling a gas adjustment part by using a single cam, and improves assemblability of the dual venturi by modularizing the gas adjustment part into an assembly.

In order to achieve the above-mentioned object, the present disclosure provides a dual venturi including: a housing having a first gas flow path formed at one side thereof, a second gas flow path formed at the other side thereof and configured to communicate with the first gas flow path, and an air flow path formed in a central region thereof and configured to communicate with the first gas flow path; an air adjustment part provided with a rotary plate provided in the air flow path and configured to rotate about a rotary shaft disposed in a height direction of the housing to adjust an opening degree of the air flow path; and a gas adjustment part provided with an opening/closing plate configured to move in a width direction of the housing in conjunction with a rotational motion of the rotary shaft and installed to selectively allow the first gas flow path and the second gas flow path to communicate with each other.

In this case, the air adjustment part may include: the rotary shaft; the rotary plate installed on the rotary shaft and configured to rotate; a drive motor installed at one side of the housing and configured to rotate the rotary shaft; and a cam member installed at an end of the rotary shaft.

Further, the gas adjustment part may include: the opening/closing plate installed in a boundary region between the first gas flow path and the second gas flow path; a shaft member having an outer surface to which the opening/closing plate is fixed, the shaft member extending in a width direction of the housing and having an end provided to be in contact with the cam member; and an elastic member installed to press the shaft member toward the cam member.

In addition, the cam member may be eccentrically installed on the rotary shaft so that the opening/closing plate departs from the boundary region and the first gas flow path and the second gas flow path communicate with each other when the air flow path is opened as the rotary plate rotates.

Further, the opening/closing plate, the shaft member, and the elastic member may be installed by being assembled to a separate casing, such that the gas adjustment part is modularized.

Further, a through-hole may be formed through a plate surface of the rotary plate so that a part of air flows even when the air flow path is closed by the rotary plate.

As described above, the dual venturi according to the present disclosure may optimize the control performance by converting the rotational motion for controlling the air adjustment part into the leftward/rightward rectilinear motion for controlling the gas adjustment part by using the single cam, and improve the assemblability of the dual venturi by modularizing the gas adjustment part into the assembly.

### BRIEF DESCRIPTION OF THE DRAWINGS

FIG. 1 is a perspective view illustrating a structure in which an air flow path of a dual venturi according to the present disclosure is closed by a rotary plate.

FIG. 2 is a cut-away perspective view illustrating the structure in which the air flow path of the dual venturi according to the present disclosure is closed by the rotary plate.

FIG. 3 is a perspective view illustrating a structure in which the air flow path and a second gas flow path of the dual venturi according to the present disclosure are opened.

FIG. 4 is a cut-away perspective view illustrating the structure in which the air flow path and the second gas flow path of the dual venturi according to the present disclosure are opened.

### DETAILED DESCRIPTION

Hereinafter, a dual venturi according to an embodiment of the present disclosure will be described in more detail with reference to the accompanying drawings.

However, the technical spirit of the present disclosure is not limited to some embodiments described herein but may be implemented in various different forms. One or more of the constituent elements in the embodiments may be selectively combined and substituted for use within the scope of the technical spirit of the present disclosure.

In addition, unless otherwise specifically and explicitly defined and stated, the terms (including technical and scientific terms) used in the embodiments of the present disclosure may be construed as the meaning which may be commonly understood by the person with ordinary skill in the art to which the present disclosure pertains. The meanings of the commonly used terms such as the terms defined in dictionaries may be interpreted in consideration of the contextual meanings of the related technology.

In addition, the terms used in the embodiments of the present disclosure are for explaining the embodiments, not for limiting the present disclosure.

In the present specification, unless particularly stated otherwise, a singular form may also include a plural form. The expression "at least one (or one or more) of A, B, and C" may include one or more of all combinations that can be made by combining A, B, and C.

In addition, the terms such as first, second, A, B, (a), and (b) may be used to describe constituent elements of the embodiments of the present disclosure.

These terms are used only for the purpose of discriminating one constituent element from another constituent element, and the nature, the sequences, or the orders of the constituent elements are not limited by the terms.

Further, when one constituent element is described as being 'connected,' 'coupled,' or 'attached' to another constituent element, one constituent element may be connected, coupled, or attached directly to another constituent element or connected, coupled, or attached to another constituent element through still another constituent element interposed therebetween.

In addition, the expression "one constituent element is provided or disposed above (on) or below (under) another constituent element" includes not only a case in which the two constituent elements are in direct contact with each other, but also a case in which one or more other constituent elements are provided or disposed between the two constituent elements. The expression "above (on) or below (under)" may mean a downward direction as well as an upward direction based on one constituent element.

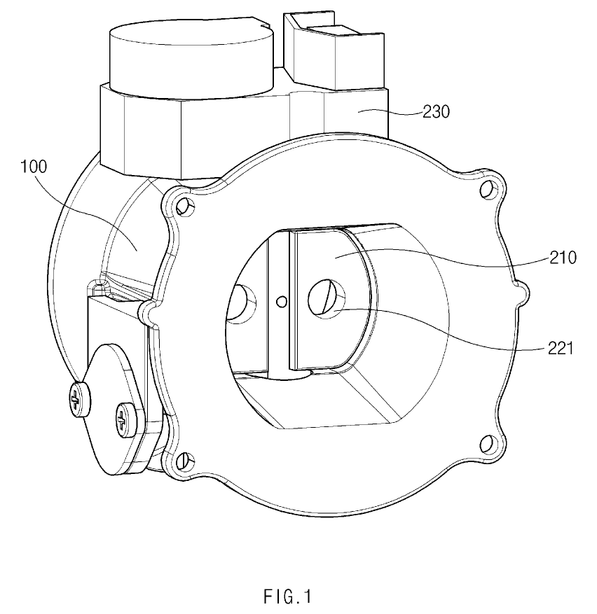

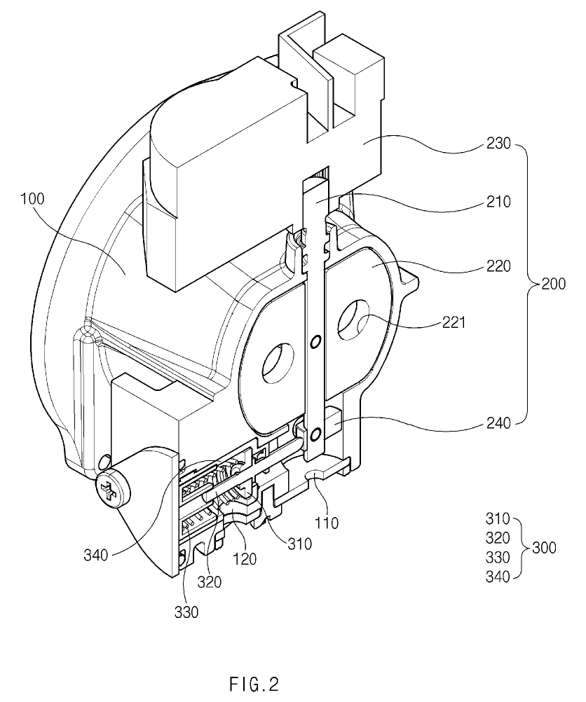

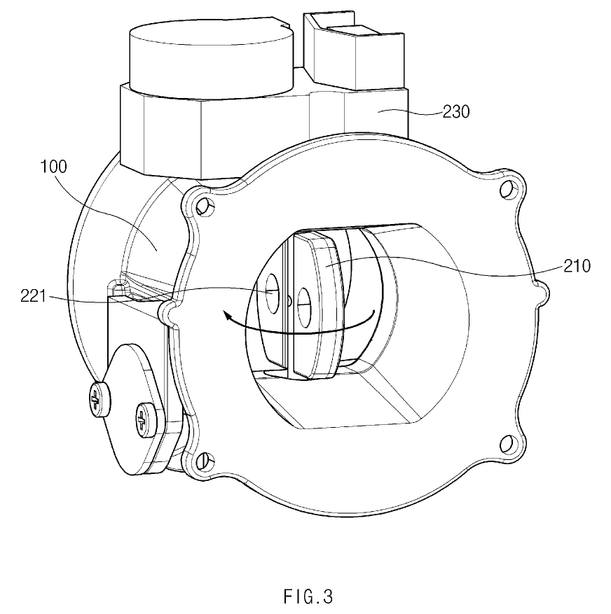

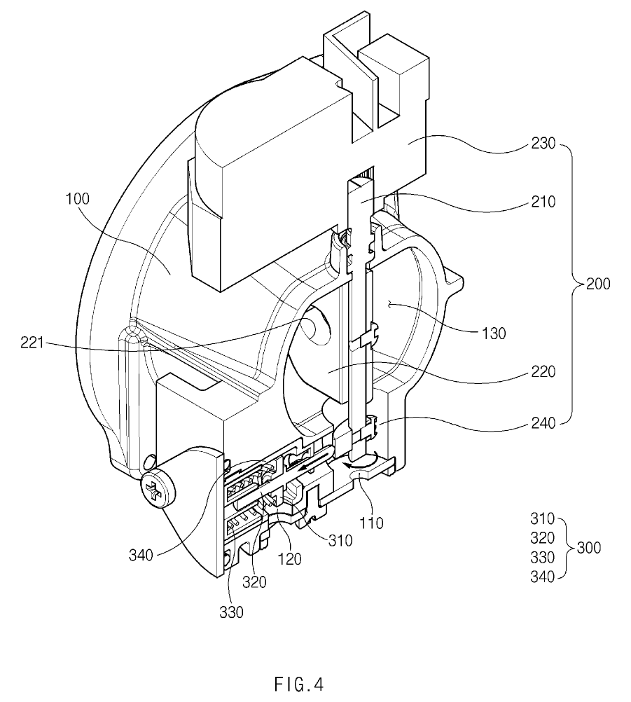

FIG. 1 is a perspective view illustrating a structure in which an air flow path of a dual venturi according to the present disclosure is closed by a rotary plate, FIG. 2 is a cut-away perspective view illustrating the structure in which the air flow path of the dual venturi according to the present disclosure is closed by the rotary plate, FIG. 3 is a perspective view illustrating a structure in which the air flow path and a second gas flow path of the dual venturi according to the present disclosure are opened, and FIG. 4 is a cut-away perspective view illustrating the structure in which the air flow path and the second gas flow path of the dual venturi according to the present disclosure are opened.

As illustrated in these drawings, the dual venturi according to the present disclosure includes: a housing 100 having a first gas flow path 110 formed at one side thereof, a second gas flow path 120 formed at the other side thereof and configured to communicate with the first gas flow path 110, and an air flow path 130 formed in a central region thereof and configured to communicate with the first gas flow path 110; an air adjustment part 200 provided with a rotary plate 220 provided in the air flow path 130 and configured to rotate about a rotary shaft 210 disposed in a height direction of the housing 100 to adjust an opening degree of the air flow path 130; and a gas adjustment part 300 provided with an opening/closing plate 310 configured to move in a width direction of the housing 100 in conjunction with a rotational motion of the rotary shaft 210 and installed to selectively allow the first gas flow path 110 and the second gas flow path 120 to communicate with each other.

The housing 100 is a member configured to define an external appearance of the dual venturi according to the present disclosure. The first gas flow path 110 and the second gas flow path 120 may be respectively formed at one side and the other side, and the first gas flow path 110 and the second gas flow path 120 may communicate with each other.

Further, the air flow path 130 may be formed in the width direction of the housing 100 while penetrating the central region of the housing 100. One side of the air flow path 130 may be installed to communicate with the first gas flow path 110 in order to supply gas, together with air, at a predetermined ratio.

To this end, the first gas flow path 110 may be formed in a lower portion of the air flow path 130, the first gas flow path 110 and the air flow path 130 may be disposed to be perpendicular to each other and communicate with each other, the second gas flow path 120 may be formed at one side adjacent to the first gas flow path 110, and the second gas flow path 120 may communicate with the first gas flow path 110.

The air adjustment part 200 serves to adjust the amount of air supplied through the air flow path 130 formed in the housing 100. As described above, the air adjustment part 200 may adjust the amount of air in accordance with a degree to which the rotary plate 220 rotates about the rotary shaft 210 provided in the air flow path 130 and disposed in the height direction of the housing 100.

More specifically, the air adjustment part 200 includes the rotary shaft 210, the rotary plate 220 installed on the rotary shaft 210 and configured to rotate, a drive motor 230 installed at one side of the housing 100 and configured to rotate the rotary shaft 210, and a cam member 240 installed at an end of the rotary shaft 210.

As described above, the rotary shaft 210 is disposed in the height direction of the housing 100 and rotatably installed in the housing 100, which makes it possible to adjust the amount of air, which is to be supplied through the air flow path 130, by adjusting a rotation degree of the rotary plate 220 fixed to an outer surface of the rotary shaft 210.

To this end, one end of the rotary shaft 210 may be connected to the drive motor 230 installed at one side of the housing 100, such that the rotation degree of the rotary shaft 210 may be controlled. The rotary plate 220 may be fixedly coupled to the outer surface of the rotary shaft 210.

The rotary plate 220 is a plate-shaped member having a longitudinal cross-sectional shape identical to a longitudinal cross-sectional shape of the air flow path 130. A peripheral surface of the rotary plate 220 may be formed in a shape corresponding to an inner surface of the air flow path 130, such that the rotary plate 220 may selectively open or close the air flow path 130.

That is, the peripheral surface of the rotary plate 220 may be disposed to be tightly attached to the inner surface of the air flow path 130, such that the air flow path 130 may be closed. The opening degree of the air flow path 130 may be adjusted in accordance with a degree to which the peripheral surface of the rotary plate 220 is spaced apart from the inner surface of the air flow path 130.

Further, a through-hole 221 may be formed through a plate surface of the rotary plate 220 so that a part of the air may flow even when the air flow path 130 is closed by the rotary plate 220.

The through-hole 221 is formed to have a circular longitudinal section. It is effective that the through-holes 221 are formed one by one in two opposite plate surfaces based on the rotary shaft 210 so that a predetermined amount of air may flow.

The drive motor 230 is disposed above the housing 100 and serves to rotate the rotary shaft 210. The drive motor 230 may control the amount of air to be supplied by adjusting the opening degree of the air flow path 130 by adjusting an angle at which the rotary shaft 210 rotates.

The cam member 240 is fixedly disposed on an outer surface of a lower end of the rotary shaft 210 and configured to rotate together with the rotary shaft 210 in accordance with the rotational motion of the rotary shaft 210. The cam member 240 may allow the rotary shaft 210 to be positioned at a position eccentric toward one side so that the cam member 240 may serve as a cam.

More specifically, the cam member 240 may be eccentrically installed at a position at which the opening/closing plate 310 to be described below may depart from a boundary region between the first gas flow path 110 and the second gas flow path 120 and allow the first gas flow path 110 and the second gas flow path 120 to communicate with each other when the rotary plate 220 rotates to open the air flow path 130.

That is, the cam member 240 may be eccentrically installed on the rotary shaft 210 and provided at a position at which a spacing distance between the opening/closing plate 310 and the boundary region may be maximized when the air flow path 130 is maximally opened by the rotary plate 220 as the rotary shaft 210 rotates.

Meanwhile, the gas adjustment part 300 is installed to selectively allow the first gas flow path 110 and the second gas flow path 120 to communicate with each other. The gas adjustment part 300 serves to allow the first gas flow path 110 and the second gas flow path 120 to communicate with each other in conjunction with the rotational motion of the rotary shaft 210.

The gas adjustment part 300 may include the opening/closing plate 310 installed in the boundary region between the first gas flow path 110 and the second gas flow path 120, a shaft member 320 having an outer surface to which the opening/closing plate 310 is fixed, the shaft member 320 extending in the width direction of the housing 100 and having an end provided to be in contact with the cam member 240, and an elastic member 330 installed to press the shaft member 320 toward the cam member 240.

The opening/closing plate 310 is a plate-shaped member movably installed in the boundary region between the first gas flow path 110 and the second gas flow path 120 and formed to have an area that may completely close a longitudinal section of a space that allows the first gas flow path 110 and the second gas flow path 120 to communicate with each other.

The opening/closing plate 310 may be fixed to the outer surface of the shaft member 320 and be movable together with the shaft member 320 in accordance with the movement of the shaft member 320.

As described above, the opening/closing plate 310 is fixed to one side of the outer surface of the shaft member 320. The shaft member 320 extends to a predetermined length, and one end of the shaft member 320 is installed to be in contact with one side of the cam member 240 provided at the end of the rotary shaft 210, such that the shaft member 320 may rectilinearly move in conjunction with the rotational motion of the rotary shaft 210.

It is effective that the end of the shaft member 320, which is in contact with the cam member 240, may be formed curvedly to minimize a frictional force with a lateral surface of the cam member 240. The shaft member 320 may be elastically supported by the separate elastic member 330 so that the shaft member 320 may be restored to an original position after the shaft member 320 is moved by the cam member 240.

The elastic member 330 is a member configured to elastically support the shaft member 320 by pressing the shaft member 320 toward the cam member 240 in order to restore the shaft member 320 to the original position, as described above. To this end, one end of the elastic member 330 is in contact with one side of the opening/closing plate 310, and the other end of the elastic member 330 is in contact with a bottom surface of a casing 340 to be described below, such that the elastic member 330 may elastically support the shaft member 320.

Further, it is effective that the gas adjustment part 300, which includes the opening/closing plate 310, the shaft member 320, and the elastic member 330, is installed by being assembled to the separate casing 340 so that the gas adjustment part 300 is modularized.

Because the components, which constitute the gas adjustment part 300, are assembled to the separate casing 340 and modularized to constitute the single assembly, it is possible to improve the assemblability of the dual venturi.

A process of adjusting the amount of air and gas to be supplied by using the dual venturi according to the present disclosure configured as described above will be described below with reference to FIGS. 1 to 4.

First, as illustrated in FIGS. 1 and 2, in case that a large amount of gas does not need to be supplied, the peripheral surface of the rotary plate 220 comes into contact with the inner surface of the air flow path 130 and closes the air flow path 130.

In this state, a region of the cam member 240, which has the shortest radius, comes into contact with the shaft member 320, and the first gas flow path 110 and the second gas flow path 120 are closed, such that a small amount of gas and a small amount air are mixed and supplied through the first gas flow path 110 and the through-holes 221 formed through the rotary plate 220.

As illustrated in FIGS. 3 and 4, in case that a large amount of gas and a large amount of air need to be supplied, the drive motor 230 rotates, and the rotary shaft 210 connected to the drive motor 230 rotates, such that the air flow path 130 is opened as the rotary plate 220 rotates together with the rotary shaft 210.

In this state, a region of the cam member 240, which has the longest radius, comes into contact with the shaft member 320, and the opening/closing plate 310 departs from the boundary region between the first gas flow path 110 and the second gas flow path 120 while moving, such that the first gas flow path 110 and the second gas flow path 120 communicate with each other, and a large amount of gas and a large amount of air are mixed and supplied.

The dual venturi according to the present disclosure configured as described above may optimize the control performance by converting the rotational motion for controlling the air adjustment part into the leftward/rightward rectilinear motion for controlling the gas adjustment part by using the single cam, and improve the assemblability of the dual venturi by modularizing the gas adjustment part into the assembly.

While the embodiments, which may be implemented by the present disclosure, have been described above, the embodiments are just illustrative and not intended to limit the present disclosure. It can be appreciated by those skilled in the art that various modifications and applications, which are not described above, may be made to the present embodiment without departing from the intrinsic features of the present embodiment. For example, the respective constituent elements specifically described in the embodiments may be modified and then carried out. Further, it should be interpreted that the differences related to the modifications and applications are included in the scope of the present disclosure defined by the appended claims.

What is claimed is:

1. A dual venturi comprising:
a housing having a first gas flow path formed at one side thereof, a second gas flow path formed at the other side thereof and configured to communicate with the first gas flow path, and an air flow path formed in a central region thereof and configured to communicate with the first gas flow path;
an air adjustment part provided with a rotary plate provided in the air flow path and configured to rotate about a rotary shaft disposed in a height direction of the housing to adjust an opening degree of the air flow path; and
a gas adjustment part provided with an opening/closing plate configured to move in a width direction of the housing in conjunction with a rotational motion of the rotary shaft and installed to selectively allow the first gas flow path and the second gas flow path to communicate with each other.

2. The dual venturi of claim 1, wherein the air adjustment part comprises:
the rotary shaft;
the rotary plate installed on the rotary shaft and configured to rotate;
a drive motor installed at one side of the housing and configured to rotate the rotary shaft; and
a cam member installed at an end of the rotary shaft.

3. The dual venturi of claim 2, wherein the gas adjustment part comprises:
the opening/closing plate installed in a boundary region between the first gas flow path and the second gas flow path;
a shaft member having an outer surface to which the opening/closing plate is fixed, the shaft member extending in a width direction of the housing and having an end provided to be in contact with the cam member; and
an elastic member installed to press the shaft member toward the cam member.

4. The dual venturi of claim 3, wherein the cam member is eccentrically installed on the rotary shaft so that the opening/closing plate departs from the boundary region and the first gas flow path and the second gas flow path communicate with each other when the air flow path is opened as the rotary plate rotates.

5. The dual venturi of claim 3, wherein the opening/closing plate, the shaft member, and the elastic member are installed by being assembled to a separate casing, such that the gas adjustment part is modularized.

6. The dual venturi of claim 1, wherein a through-hole is formed through a plate surface of the rotary plate so that a part of air flows even when the air flow path is closed by the rotary plate.
